(19) United States
(12) Patent Application Publication
(10) Pub. No.: US 2009/0295026 A1
(43) Pub. Date: Dec. 3, 2009

(54) SYSTEM FOR SUPPLYING AN INTERNAL COMBUSTION ENGINE AND METHOD OF MANUFACTURING A TANK COMPRISED IN THE SYSTEM

(75) Inventor: Bertrand THISSELIN, Compiegne (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: INERGY AUTO. SYSTEMS RESEARCH (SOCIETE ANONYME), Bruxelles (BE)

(21) Appl. No.: 12/540,571

(22) Filed: Aug. 13, 2009

Related U.S. Application Data
(62) Division of application No. 10/573,474, filed on Oct. 11, 2006.

(30) Foreign Application Priority Data
Sep. 26, 2003 (FR) 03.11275

(51) Int. Cl. B29C 45/14

(52) U.S. Cl. 264/250

(57) ABSTRACT

System for supplying an internal combustion engine with a liquid fuel, comprising a tank, a pipe for the circulation of hot fuel between the engine and the tank and at least one sealed composite junction conduit for joining the pipe to the tank. The composite junction conduit comprises at least two hollow components each based on a different plastic, the said components being mechanically attached to each other and in communication with each other and include, between them, an overmoulded seal.

### REFERENCE TO PRIOR APPLICATIONS

This application is a Divisional of U.S. application Ser. No. 10/573,474, filed Oct. 11, 2006; which is a 371 application of PCT/EP04/52314, filed Sep. 24, 2004; and to French patent application 03 11275, filed Sep. 26, 2003, all incorporated herein by reference.

### FIELD OF THE INVENTION

The invention relates to sealed conduits for the flow of fluids (liquids and/or gases).

It relates more especially to a sealed composite conduit formed by joining together at least two hollow components made of thermoplastic.

### PRIOR ART

In the automobile industry, great use is made of thermoplastics in internal combustion engine supply systems. The thermoplastics are especially used for the manufacture of fuel tanks and the pipes connecting them to the engine combustion chambers.

Motor car fuel tanks are conventionally produced by extrusion-blow moulding technology. A shell is thus obtained through which openings intended to accommodate functional devices of the engine fuel supply system are produced.

The pipes serving to supply the combustion chambers of the engine with fuel are usually connected to the fuel tank via calibrated nozzles. The use of ever higher temperatures for the fuel flowing in these pipes (the temperature may reach 130° C. and higher in the case of high-efficiency diesel engines) and the increased severity of standards relating to the emission of hydrocarbons into the atmosphere require the use of complex nozzles, exhibiting, simultaneously, high thermal resistance, high mechanical resistance, low permeability to the vapour of volatile fuels and the capability of being hermetically sealed to the tank and to the pipe.

To achieve this result, Document U.S. Pat. No. 5,443,098 proposes a two-material nozzle comprising two juxtaposed tubes, made respectively of two different thermoplastic polymers. The tube intended to be connected to the tank is made of an olefin polymer (high-density polyethylene is suggested) and the tube intended to be connected to the pipe is made of a polymer of high thermal resistance [polyamide resins are proposed, in particular those commercially available under the name Nylon® (DuPont)]. The nozzle is obtained by the injection moulding technique, the two tubes being produced by double-shot injection moulding so as to join them together. When the polymers of the two tubes are incompatible, they are chemically modified in order to make them adhere.

The manufacture of these known nozzles is difficult and expensive. In particular, it is generally difficult to produce a hermetically sealed and mechanically strong join between the two tubes. In addition, each time that a change has to be made to one polymer (for example in order to meet the requirements of a specification), it is consequently necessary to adapt the chemical modification of the material of both tubes of the nozzle. These known nozzles thus have the additional disadvantage of lacking flexibility as regards their construction.

### SUMMARY OF THE INVENTION

The invention aims to remedy the abovementioned drawbacks of known two-material conduits and used for the circulation of a hot fluid (and more particularly in the case of high-efficiency diesel engines) by providing a two-material conduit in which the join between the constituent components is hermetically sealed and mechanically and thermally robust, the manufacture of which is inexpensive and independent of the nature of the polymers employed in the two components of the conduit.

The invention relates to a system for supplying an internal combustion engine with a liquid fuel, comprising a tank, a pipe for the circulation of hot fuel between the engine and the tank and at least one sealed composite junction conduit for joining the pipe to the tank, characterized in that the composite junction conduit comprises at least two hollow components each based on a different plastic, the said components being mechanically attached to each other and in communication with each other and include, between them, an overmoulded seal.

In the supply system according to the invention, the tank is intended to contain the fuel for the engine. It is no matter whether this fuel is petrol, oil, gas-oil, alcohol or liquefied gas. The plastic of the tank is chosen from those that are impermeable to the fuels normally contained in the tank and are chemically inert with respect to the said fuels. It is advantageous to use polymers and copolymers derived from olefins, particularly ethylene. Polyethylene, and in particular high-density polyethylene, is especially recommended in the case of tanks intended for volatile combustible liquids derived from oil.

The pipe connected to the engine usually includes a manifold for the intake of fuel into the combustion chambers of the engine. As a variant, especially in the case of diesel engines, it may include a manifold for returning fuel from the combustion chambers to the tank. The pipe is made of an impermeable plastic that is chemically inert with respect to the fuel flowing therein and capable of retaining its mechanical properties at the temperature of the fuel flowing therein (this temperature may in certain applications exceed 100° C. and reach 120 or 130° C. or higher). In practice, lactam-derived polymers and copolymers, polyamide resins and polyacetals are very suitable.

In the supply system according to the invention, the tank and the abovementioned pipe are connected together via a sealed composite junction conduit which, in accordance with the invention, is formed by joining two hollow plastic components together. In the supply system according to the invention, one of the hollow components of the sealed composite junction conduit may be made from the same polymeric material as the tank and the other hollow component may be made from the same polymeric material as the pipe. Preferably, the material of the seal is impermeable to the engine fuel and chemically inert with respect to it.

The supply system according to the invention thus includes a sealed composite conduit, comprising at least two hollow components each based on a different plastic, the said components being attached to each other and in communication with each other; according to the invention the two components are mechanically attached to each other and include, between them, an overmoulded seal made of an elastomeric or of any other material conventionally used in the production of seals.

The composite conduit comprised in the system according to the invention is used for conveying hot fluids, which may be liquids, gases or vapours. Preferably, at least one part of the composite conduit is impermeable to the fluids for which it is normally intended.

In the context of the invention, “hot fluids” means fluids whose temperature is higher than the ambient temperature, preferably higher than 100° C., more preferably more than 120° C.

The composite conduit is formed by joining together at least two hollow components. As a variant, it may comprise more than two hollow components, depending on its application. The hollow components are designed to allow the fluids to flow in the normal applications of the composite conduit.

By definition, the plastics of the components of the composite conduit comprised in the system according to the invention allow the said components to be manufactured by moulding. They are normally synthetic polymers or copolymers. The choice of plastics is not critical as regards the invention and will essentially depend on the application for which the composite conduit is intended. In general, the plastic of each hollow component is selected from those that are mechanically and chemically resistant to the fluids that are required to flow therein, at normal operating temperatures and pressures. In general, thermoplastic polymers and copolymers are preferred. According to the invention, the hollow components of the composite conduit are based on different plastics, exhibiting different physical and/or chemical properties (for example a different melting point or a different mechanical strength).

The term “based on” is understood to mean that the material in question is the predominant constituent (by weight) of each component. This does not exclude the fact that the plastics may include additives, such as fillers, pigments, stabilizers, plasticizers, etc., commonly used for plastics. Nor does it exclude the fact that it may be a blend of plastics.

The shape and dimensions of the hollow components are not critical as regards the invention and will also depend on the use for which the composite conduit is intended. To give an example, the hollow components may take the form of straight or curved channels, pipes, nozzles or manifolds, of circular, cylindrical or annular chambers or of those of any other suitable profile. The two components may have the same profile or the same shape, or have different shapes or profiles, provided that when they are joined together a sealed composite conduit can be formed.

According to the invention, the two hollow components include, between them, an overmoulded seal. In the present specification, the expression “overmoulded seal” means that the seal is held captive between the two components by overmoulding one of said components over the other. By definition, the overmoulding of one component over another component is a moulding operation, in which one of the components is moulded in a mould already containing the other component, the latter having been manufactured beforehand by any suitable means. Overmoulding is a technique well known for the moulding of plastics.

The function of the overmoulded seal of the composite conduit comprised in the system according to the invention is to provide a sealed joint between the two hollow components. Its shape will therefore depend on the shape of the two components and it must be determined in each particular case. In general, it is preferred to use an annular seal, those with a circular or semicircular cross section being preferred. The material of the seal is not critical as regards the invention. It will essentially depend on the use for which the composite conduit comprised in the system according to the invention is intended. In general, the material of the overmoulded seal is selected from those that are capable of mechanically and chemically resisting the fluids that are required to flow, in contact with the material, in the composite conduit, at normal operating temperatures and pressures. For example, the seal may be made of a natural or synthetic rubber. In general, synthetic polymers, which may or may not be elastomers, are preferred. Elastomeric polymers and copolymers are preferred. More preferably elastomers such as nitrils, fluorocarbons and fluorosilicones are used.

Moreover, in accordance with the invention, the two components of the composite conduit are mechanically attached to each other. It should be understood by this expression that an essentially mechanical bond (as opposed to a chemical bond) links the two components and fastens them together. Any suitable mechanical means can be used to make the mechanical connection between the two components.

In a preferred embodiment of the composite conduit comprised in the system according to the invention, the two hollow components are mechanically attached by means of a catching element forming part of one of the two components, which element is embedded in the constituent plastic of the other component during the overmoulding, in accordance with the abovementioned definition of overmoulding.

The composite conduit comprised in the system according to the invention is advantageously applicable for joining pipes, tanks or other members intended for conveying gases, vapours or liquids. It is advantageously applicable in the automobile industry, for internal combustion engine supply circuits. In internal combustion engines, a combustible fluid is generally made to flow along pipes between regions at high temperature and regions at lower temperature. Thus, in high-performance diesel engines, it is usual for the fuel flowing in the return line from the combustion chambers or from a high pressure pump of a common rail or from injectors to have a temperature above 100° C., generally close to 120 to 130° C., whereas in the vehicle's tank its temperature is substantially equal to the ambient temperature. The fuel system according to the invention is advantageously applicable in this type of vehicle for returning the hot fuel to the tank. In this application of the invention, one of the components of the composite conduit comprised in the system according to the invention is directly coupled to the fuel tank, while the other component is hermetically coupled to a hose that may for example include a hot gas or liquid manifold.

In one particular embodiment of the composite conduit comprised in the system according to the invention, especially well suited for the application that has just been described, one of the hollow components of the conduit comprises a nozzle that is engaged in a socket forming at least part of the other component, the overmoulded seal is interposed between the nozzle and the socket, the socket is hermetically coupled to a tank (for example by welding) and the nozzle is hermetically coupled to a hose (for example by welding or by means of a mechanical joint, for example a hose clip). This embodiment of the invention is especially designed for equipping internal combustion engines used for propelling motor vehicles (cars, lorries, boats, locomotives) or for driving machines (for example piston engines or gas turbines used for driving alternators). In this application of the invention, the socket may generally be made of a plastic selected from olefin polymers and copolymers. Polyethylene (especially high-density polyethylene) is particularly recommended in the case of tanks intended for volatile combustible liquids derived from oil. The nozzle is made of a plastic selected from polymers and copolymers that can withstand the high temperatures of the fuel. The most appropriate (co)polymer must be determined by a person skilled in the art for each particular case depending on the circumstances. Polyamide resins and polymers and copolymers derived from lactams are very suitable, especially polydodecanolactam (PA12) and polyacetals, in particular the polyoxymethylen (POM). It can be also necessary to include a filler, such as glass fibers, in the polymer in order to achieve better mechanical properties (eg. mechanical strength). During the injection process of the conduit, glass fibers tend to orient themselves, in particular along the flow lines of the injected material. It is thus particularly advantageous to use POM that helps achieving equivalent mechanical properties without additional fillers. The seal may be made of a thermoplastic polymer, preferably an elastomer, this being advantageously selected from olefin polymers, olefin copolymers, vinyl (co)polymers, nitrils and fluoroelastomers. The latter give good results.

In another particular embodiment of the composite conduit comprised in the system according to the invention, a metal disc is inserted between the two components. This disc is advantageously overmoulded between the two components, in accordance with the abovementioned definition of overmoulding. In this embodiment of the invention, the function of the metal disc is to allow the composite conduit comprised in the system according to the invention to be detected by means of a metal detector, for example in a recycling or material recovery process. The disc may be made of any metallic material (metal, alloy or metallic compound) that can be located by a metal detector. Its shape and its dimensions are not critical as regards the invention and must be selected in order to allow it to be detected by a metal detector. The position of the disc in the composite conduit is not critical as regards the invention. It is preferably located in a region of the conduit where it runs no risk of coming into contact with the fluid flowing in the conduit during normal use of the latter.

The invention also relates to a method of manufacturing a tank comprised in a system according to the invention, characterized in that a sealed composite junction conduit for joining the pipe to the tank, is manufactured by joining a first hollow component made of a plastic to a second hollow component made of a different plastic, in such a way that the first component is firstly formed, this first component and a seal are then deposited in a mould, and then the second component is formed by moulding, in the said mould, over the first component and the seal.

The two hollow components and the seal used in the method according to the invention were defined above.

In the method according to the invention, the way in which the first hollow component is manufactured is not critical. It is preferred to choose a moulding, advantageously an injection moulding, process.

To manufacture the second hollow component, the molten plastic of the latter is poured into a suitable mould, over the first component (that has solidified beforehand) and the seal. The molten plastic of the second component thus progressively encapsulates the seal, which provides the required sealing between the two components, after the plastic of the second component has solidified. Advantageously, the method of injection moulding is used for the second hollow component.

The seal must be designed so as to allow it to be inserted in a sealed manner between the two components, while the second component is being poured over the first component in the mould. Notwithstanding this condition, the shape of the seal, its dimensions, the material of which it is formed and its method of manufacture are not critical as regards the invention and essentially depend on the shape, the dimensions and the application of the composite conduit to be manufactured.

In one particular way of implementing the method according to the invention, the first hollow element is provided with a catching element that is then embedded in the plastic of the second component during moulding of the latter. After the plastic of the second hollow component has solidified, the catching element produces a kind of mechanical connection between the two components, retaining the seal in the sealed position between the two components. In this way of implementing the method according to the invention, the catching element may form an integral part of the first component and be obtained during moulding of the latter.

In another particular way of implementing the method according to the invention, before the plastic of the second component is poured into the mould, a metal disc is deposited in the mould containing the first component. The metal disc and its function were explained above. In this way of implementing the invention, the position of the metal disc is arranged in such a way that it is retained in the wall of the composite conduit after the latter has been removed from the mould.

The composite conduit comprised in the system according to the invention is suitable for the flow of liquids, gases or vapours. It is especially suitable for serving as coupling conduit between installations containing fluids at different temperatures, generally between an installation containing a fluid at high temperature and another installation containing the same fluid at a lower temperature. As a variant, it may serve for coupling two installations that contain the same chemical substance in two different states (the liquid state in one installation and the gaseous state in the other installation).

There are many applications of the composite conduit according to the invention for the flow of liquids, gases or vapours, especially in the chemical industry and the petrochemical industry.

The conduit comprised in the system according to the invention is especially applicable in the automobile industry, for supplying internal combustion engines with a fuel.

The conduit comprised in the fuel system manufactured according to the invention may also consist of a nipple having low permeation properties against fuel vapours.

### BRIEF DESCRIPTION OF THE DRAWINGS

Particular features and details of the invention will be apparent from the following description of the appended figures:

FIG. 1 is a half-section/half-view of one particular embodiment of the composite conduit according to the invention;

FIG. 2 is a section in side view of the composite conduit of FIG. 1; and

FIG. 3 is a plan view of the composite conduit of FIGS. 1 and 2.

The figures have not been drawn to scale. In general, the same reference numbers denote the same components.

### DETAILED DESCRIPTION OF PARTICULAR EMBODIMENTS

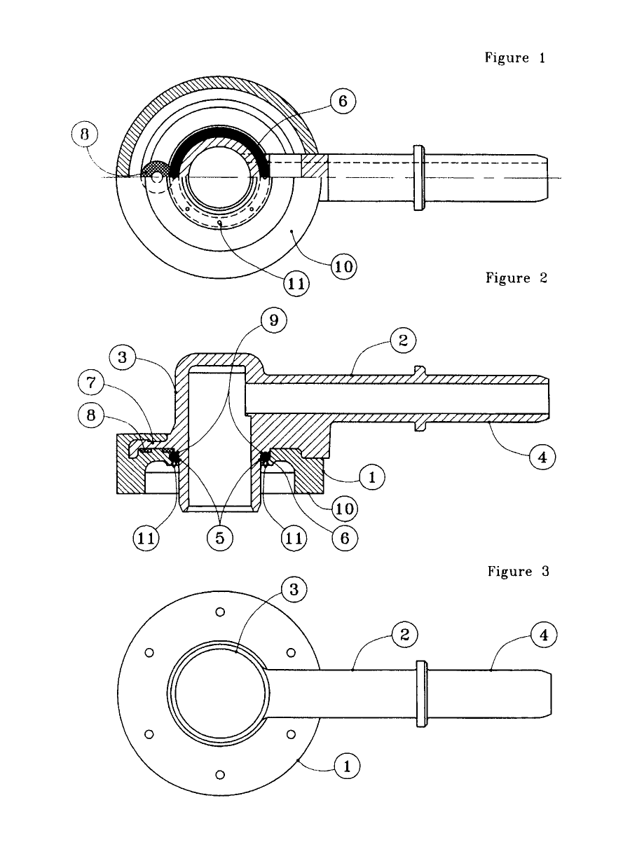

The composite conduit shown in FIGS. 1 to 3 comprises a cylindrical socket 1 made of high-density polyethylene (HDPE) and a nozzle 2 made of polydodecanolactam (PA12). The nozzle 2 has two straight parts 3 and 4 making approximately a right angle between them. The part 3 of the nozzle 2 passes through a circular opening 5 in the socket 1. The circular opening 5 contains an O-ring seal 6 made of a fluoroelastomer (FPM). A lateral flange 7 of the nozzle 2, inserted into a corresponding notch in the socket 1, constitutes a catching element for making a mechanical connection, rendering the socket 1 inseparable from the nozzle 2.

A metal disc 8 is also inserted between the socket 1 and the nozzle 2. The socket 1 is intended to be welded, on its front face 10, to an HDPE tank of a vehicle and the part 4 of the nozzle 2 is intended to be connected to a pipe connected to the engine of the vehicle.

Manufacture of the composite conduit shown in the figures starts with the manufacture of the nozzle 2 in an injection mould. After the PA12 has solidified, the nozzle 2, including its two parts 3 and 4 and its lateral flange 7, are collected from the mould. Next, the nozzle 2 is deposited in a mould suitable for forming the socket 1, the seal 6 is inserted around the part 3 of the nozzle, so that it butts against a shoulder 9 of the latter, and retaining rods are deposited under this seal in order to keep it in place. The metal disc 8 is deposited in the mould, at the point provided on the nozzle 2. Next, the plastic for the socket 1 is poured into the mould so that it overmoulds and embeds the seal 6, the flange 7 of the nozzle 2 and the disc 8. Finally, the part is removed from the mould and the rods for retaining the seal are removed, leaving recesses 11 in the cylindrical socket 1.

1. A method of manufacturing a sealed composite junction conduit, comprising:
joining a first hollow component made of plastic to a second hollow component made of a different plastic, in such a way that the first component is firstly formed by moulding,
this first component and a plastic seal are deposited in a mould,
retaining rods are deposited under the seal in order to keep the seal in place,
the second component is formed by moulding, in the mould, over the first component and the seal, the seal being an annular seal made of an elastomeric polymer or copolymer which is progressively encapsulated by the plastic of the second component when said plastic is poured over the first component in the mould,
removing the sealed composite junction conduit from the mould and
removing the rods for retaining the seal.

2. The method according to claim 1, wherein the first hollow component is provided with a catching element that is then embedded in the plastic of the second component during moulding of the latter.

3. The method according to claim 2, wherein for moulding the first component, a plastic having a higher thermal resistance than that of the plastic of the second component is selected.

4. The method according to claim 1, wherein, before the second component is formed, a metal disc is placed in the mould containing the first component.

5. The method according to claim 4, wherein the plastic of the second component is selected from olefin (co)polymers, the plastic of the first component is selected from lactam-derived (co)polymers, polyamide resins and polyacetals and the seal is made of a elastomer selected from nitrils and fluoroelastomers.

6. The method according to claim 5, wherein the plastic of the first component is polyoxymethylene (POM).
